(19) United States
(12) Patent Application Publication
(10) Pub. No.: US 2025/0109329 A1
(43) Pub. Date: Apr. 3, 2025

(54) METHODS OF DELAYING THE DISSOLUTION RATE OF DISSOLVABLE RUBBERS

(71) Applicants: CNPC USA CORP., Houston, TX (US); BEIJING HUAMEI, INC., Beijing (CN); CHINA NATIONAL PETROLEUM CORPORATION, Beijing (CN)

(72) Inventors: Jiaxiang (Jason) REN, Houston, TX (US); Peng CHENG, Houston, TX (US); Yu LIU, Beijing (CN)

(21) Appl. No.: 18/477,066

(22) Filed: Sep. 28, 2023

(51) Int. Cl. C09K 8/42

(52) U.S. Cl. CPC C09K 8/426

(57) ABSTRACT

The patent application discloses an apparatus. The apparatus comprises a dissolvable polymeric substrate formed into a downhole tool; and a polymeric coating adhered to at least a portion of the polymeric substrate. The polymeric coating comprises a polymer having the formula:

—[R(R¹ₓ)(R²_{y})]ₙ—,
wherein R is aryl, or —C(R³ₚ) (R⁴_{q})-aryl-C(R⁵ᵣ)(R⁶ₛ), and n is an integer ranging from 10 to 50,000.

### TECHNICAL FIELD AND INDUSTRIAL APPLICABILITY

The present invention relates generally to the field of oilfield exploration, production, and more specifically to methods of delaying the dissolution rate of dissolvable rubbers.

### BACKGROUND

Dissolvable plugs have been used extensively for non-conventional oil and gas production to replace millable composite plugs. After the fracturing, the dissolvable plug could be dissolved in the downhole fluids. Therefore, the milling operation time and cost were saved. The dissolvable elastomer was an essential component of the dissolvable plug. The dissolvable elastomer needs to keep good elasticity for certain time period, such as more than 24 hours to complete the fracturing operation. On the other hand, the dissolvable elastomer needs to be dissolved as fast as possible after performing the fracturing operation.

There is a need, therefore, for a packer that can effectively seal the wellbore at high temperature and high pressure wellbore conditions and dissolve quickly.

### SUMMARY

In one aspect, one embodiment discloses an apparatus. The apparatus comprises:
(a) a dissolvable polymeric substrate formed into a downhole tool; and
(b) a polymeric coating adhered to at least a portion of the polymeric substrate. The polymeric coating comprises a polymer having the formula: —[R(R¹ₓ)(R²_{y})]ₙ—, wherein R is aryl, or —C(R³ₚ) (R⁴_{q})-aryl-C(R⁵ᵣ)(R⁶ₛ), and n is an integer ranging from 10 to 10,000. If R is aryl, R¹ and R² are the same or different and are any organic or inorganic group that can be substituted on aromatic nuclei, and x and y are integers ranging from 0 to m, and x+y≤m, wherein m is the maximum number of substitution positions on the aryl, if R is —C(R³ₚ)(R⁴_{q})-aryl-C(R⁵ᵣ)(R⁶ₛ)—, x and y are integers ranging from 0 to m, and x+y≤m, wherein m is the maximum number of substitution positions on the aryl, R¹ and R² are attached to the aryl group and are independently selected from any organic or inorganic group that can be substituted on aromatic nuclei, R³, R⁴, R⁵, R⁶ are independently selected from halogen atoms and hydrogen atoms, p, g, r, and s may be 0, 1, or 2, with p+q=2 and r+s=2.

Optionally in any aspect, the polymer in the polymeric coating has the following formula

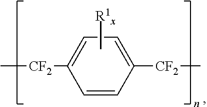

wherein, n is an integer ranging from 10 to 10,000, x is an integer ranging from 0 to 4, R1 is selected from alkyl, aryl, alkenyl, amino, cyano, carboxyl, alkoxy, hydroxy alkyl, carboalkoxy, hydroxyl, nitro, hydrogen atom, and a halogen atom.

Optionally in any aspect, the polymer in the polymeric coating is selected from poly-(p-xylylene), poly-(chloro-p-xylylene), poly-(di-chloro-p-xylylene), poly-(bromo-p-xylylene), poly-(cyano-p-xylylene), poly-(isopropyl-p-xylylene)and poly-(ethyl-p-xylylene).

Optionally in any aspect, wherein R is aryl, and the polymer in the polymeric coating is selected from polynaphthalene, polyanthracene, polyphenanthrene, polyphenylene, derivatives thereof, and combinations thereof.

Optionally in any aspect, the dissolvable polymeric substrate comprises a polymer selected from thermoplastic polymers, elastomers, composites, and combinations thereof.

Optionally in any aspect, the polymeric coating comprises polymers selected from thermoset polymers, thermoplastic polymers, and combinations thereof.

Optionally in any aspect, the polymeric coating is conformal to at least a portion of a surface of the polymeric substrate.

Optionally in any aspect, the polymeric coating comprises a polymer selected from polyurethanes, polyacrylates, and epoxy polymers.

Optionally in any aspect, the dissolvable polymeric substrate comprises a polymer selected from polyester-polyurethane copolymer, polyether-polyurethane copolymer, or polycarbonate-polyurethane copolymer, or the combination and combinations thereof.

Optionally in any aspects, the polymeric coating is adhered to a primed surface of the polymeric substrate.

Optionally in any aspects, the apparatus is selected from tubing, jointed pipe, sucker rods, electric submersible pumps, submersible pump motor protector bags, packers, packer elements, blow out preventers, blow out preventer elements, O-rings, T-rings, centralizers, hangers, plugs, plug catchers, check valves, universal valves, spotting valves, differential valves, circulation valves, equalizing valves, safety valves, fluid flow control valves, sliding seals, connectors, disconnect tools, downhole filters, motorheads, retrieval and fishing tools, bottom hole assemblies, seal assemblies, snap latch assemblies, anchor latch assemblies, shear-type anchor latch assemblies, no-go locators, sensor protectors, gaskets, pump shaft seals, tube seals, valve seals, seals and insulators used in electrical components, seats used in fiber optic connections, pressure sealing elements for fluids and combinations thereof.

Further in another aspect, one embodiment discloses an oilfield assembly for exploring, drilling, or producing hydrocarbons. The oilfield assembly comprises one or more oilfield elements selected from tubing, jointed pipe, sucker rods, electric submersible pumps, submersible pump motor protector bags, packers, packer elements, blow out preventers, blow out preventer elements, O-rings, T-rings, centralizers, hangers, plugs, plug catchers, check valves, universal valves, spotting valves, differential valves, circulation valves, equalizing valves, safety valves, fluid flow control valves, sliding seals, connectors, disconnect tools, downhole filters, motorheads, retrieval and fishing tools, bottom hole assemblies, seal assemblies, snap latch assemblies, anchor latch assemblies, shear-type anchor latch assemblies, no-go locators, sensor protectors, gaskets, pump shaft seals, tube seals, valve seals, seals and insulators used in electrical components, seals used in fiber optic connections, pressure sealing elements for fluids, and combinations thereof, wherein at least one of the one or more oilfield elements comprises a dissolvable polymeric substrate having a polymeric coating adhered to at least a portion of the dissolvable polymeric substrate, wherein the polymeric coating comprises a polymer having the formula —[R(R¹ₓ)(R²_{y})]ₙ—, wherein R is aryl, or —C(R³ₚ)(R⁴_{q})-aryl-C(R⁵ᵣ)(R⁵ₛ), and n is an integer ranging from 10 to 10,000, if R is aryl, R¹ and R² are the same or different and are any organic or inorganic group that can be substituted on aromatic nuclei, and x and y are integers ranging from 0 to m, and x+y≤m, wherein m is the total number of available aryl substitution positions, if R is —C(R³ₚ)(R⁴_{q})-aryl-C(R⁵ᵣ)(R⁶ₛ)—, x and y are integers ranging from 0 to 4, and x+y≤m, wherein m is the maximum number of substitution positions on the aryl, R¹ and R² are attached to the aryl group and are independently selected from any organic or inorganic group that can be substituted on aromatic nuclei, R³, R⁴, R⁵, and R⁶ are independently selected from halogen atoms and hydrogen atoms, p, g, r, and s may be 0, 1, or 2, with p+q=2 and r+s=2.

Optionally in any aspects, the polymer in the polymeric coating has the following formula

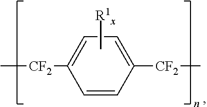

wherein, n is an integer ranging from 10 to 50,000, x is an integer ranging from 0 to 4, R1 is selected from alkyl, aryl, alkenyl, amino, cyano, carboxyl, alkoxy, hydroxy alkyl, carboalkoxy, hydroxyl, nitro, hydrogen atom, and a halogen atom.

In yet another aspect, one embodiment discloses a method. The method comprises steps of (a) selecting one or more oilfield elements having a component comprising a dissolvable polymeric substrate having a polymeric coating adhered to at least a portion of the dissolvable polymeric substrate, wherein: the polymeric coating comprises a polymer having the formula —[R(R¹ₓ)(R²_{y})]ₙ—, wherein R is aryl, or —C(R³ₚ)(R⁴_{g})-aryl-C(R⁵ᵣ)(R⁶ₛ)—, and n is an integer ranging from 10 to 10,000, if R is aryl, R¹ and R² are the same or different and are any organic or inorganic group that can be substituted on aromatic nuclei, and x and y are integers ranging from 0 to m, and x+y≤m, wherein m is the maximum number of substitution positions on the aryl, if R is —C(R³ₚ)(R⁴_{q})-aryl-C(R⁵ᵣ)(R⁶ₛ)—, x and y are integers ranging from 0 to m, and x+y≤m, wherein m is the maximum number of substitution positions on the aryl, R¹ and R² are attached to the aryl group and are independently selected from any organic or inorganic group that can be substituted on aromatic nuclei, R³, R⁴, R⁵, and R⁶ are independently selected from halogen atoms and hydrogen atoms, p, g, r, and s may be 0, 1, or 2, with p+q=2 and r+s=2; and
(b) using the oilfield element in an oilfield operation, thus exposing the oilfield element to an oilfield environment.

Optionally in any aspects, the one or more oilfield elements are selected from tubing, jointed pipe, sucker rods, electric submersible pumps, submersible pump motor protector bags, packers, packer elements, blow out preventers, blow out preventer elements, O-rings, T-rings, centralizers, hangers, plugs, plug catchers, check valves, universal valves, spotting valves, differential valves, circulation valves, equalizing valves, safety valves, fluid flow control valves, sliding seals, connectors, disconnect tools, downhole filters, motorheads, retrieval and fishing tools, bottom hole assemblies, seal assemblies, snap latch assemblies, anchor latch assemblies, shear-type anchor latch assemblies, no-go locators, sensor protectors, gaskets, pump shaft seals, tube seals, valve seals, seals and insulators used in electrical components, seals used in fiber optic connections, pressure sealing elements for fluids, and combinations thereof.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1 illustrates a schematic side elevation view of a plug having polymer-coated elastomer packer elements in accordance with the invention;

FIG. 2 illustrates a series of picture view of dissolution progress of a dissolvable rubber DR-127 non-coated, DR-127 poly (Para-xylene) b coated at 140° C., 0.3% KCl, 24 hrs and then 95C, 0.3% KCl for 15 days;

FIG. 3 illustrates weight loss of dissolvable rubber DR-127 non-coated, DR-127 (Para-xylene) b coated at 140° C., 0.3% KCl, 24 hrs and then 95° C., 0.3% KCl for 15 days;

FIG. 4 illustrates pressure holding test results of the dissolvable plug with poly (para-xylene) b coated DR-127 element;

FIG. 5 illustrates dissolution testing results of high temperature dissolvable plug with poly (para-xylene) b coated DR-127 element at 95° C., 1% KCl;

FIG. 6 illustrates dissolution testing of HT dissolvable plug with poly(para-xylene) b coated DR-127 element at 95° C., 1% KCl for first 48 hrs and then at 130° C. 1% KCl for totally 96 hrs.

### DETAILED EMBODIMENTS

### Definitions

Unless otherwise indicated, all numbers expressing quantities of ingredients, properties such as size, weight, reaction conditions and so forth used in the specification and claims are to the understood as being modified in all instances by the term “about”. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

The term “about” means plus or minus 20%, more preferably plus or minus 10%, even more preferably plus or minus 5%, most preferably plus or minus 2%.

The invention is not limited to the particular methodology, protocols, and reagents described herein because they may vary. Further, the terminology used herein is for the purpose of describing particular embodiments only and is not intended to limit the scope of the present invention. As used herein and in the appended claims, the singular forms “a,” “an,” and “the” include plural reference unless the context clearly dictates otherwise.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All percentages for weights expressed herein are by weight of the total product unless specifically stated otherwise.

The technical means, creative features, objectives, and effects of the patent application may be easy to understand, the following embodiments will further illustrate the patent application. However, the following embodiments are only the preferred embodiments of the utility patent application, not all of them. Based on the examples in the implementation manners, other examples obtained by those skilled in the art without creative work shall fall within the protection scope of the present invention. The experimental methods in the following examples are conventional methods unless otherwise specified. The materials and reagents used in the following examples can be obtained from commercial sources unless otherwise specified.

### EXEMPLARY EMBODIMENTS

Herein disclosed are novel systems, and methods that pertain to downhole tools usable for wellbore operations, details of which are described herein.

The plug may be suitable for frac operations. In an exemplary embodiment, the plug may be a composite plug made of dissolvable material, the plug being suitable for use in vertical or horizontal wellbores. The exemplary embodiment discloses methods to delay the dissolving rate of the dissolvable rubbers, especially high temperature dissolvable rubbers by designing specific coatings and coating thickness. The dissolvable plug with the poly (para-xylene) b 12 μm coated high temperature dissolvable rubber element passed 150° C., 10 ksi, 24 hours pressure holding test in water and then dissolved in brine at 95° C. in less than 15 days. This is the first time reported in the industry that a high temperature dissolvable plug could meet both requirements.

Broadly, the present embodiment discloses method or design to form dissolvable plug with a unique formulation and processing that enable plug forming and dissolving functions.

In the following description, numerous details are set forth to provide an understanding of the present invention. However, it will be understood by those skilled in the art that the present invention may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romanic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

The invention describes coated polymeric components useful in oilfield applications, including exploration, drilling, and production activities. As used herein the term “oilfield” includes land based (surface and sub-surface) and sub-seabed applications, and in certain instances seawater applications, such as when exploration, drilling, or production equipment is deployed through seawater. The term “oilfield” as used herein includes oil and gas reservoirs, and formations or portions of formations where oil and gas are expected but may ultimately only contain water, brine, or some other composition. A typical use of the coated polymeric components will be in downhole applications, such as pumping fluids from or into wellbores.

### Polymeric Substrate Materials

Polymeric substrate materials useful in the invention may be selected from natural and synthetic polymers, blends of natural and synthetic polymers, and layered versions of polymers, wherein individual layers may be the same or different in composition and thickness.

The term “polymeric substrate” includes composite polymeric materials, such as, but not limited to, polymeric materials having fillers, plasticizers, and fibers therein. The polymeric substrate may comprise one or more thermoplastic polymers, one or more thermoset and/or thermally cured polymers, one or more elastomers, composite materials, and combinations thereof.

One class of useful polymeric substrates are the elastomers. “Elastomer” as used herein is a generic term for substances emulating natural rubber in that they stretch under tension, have a high tensile strength, retract rapidly, and substantially recover their original dimensions. The term includes natural and man-made elastomers, and the elastomer may be a thermoplastic elastomer or a non-thermoplastic elastomer. The term includes blends (physical mixtures) of elastomers, as well as copolymers, terpolymers, and multi-polymers. Useful elastomers may also include one or more additives, fillers, plasticizers, and the like.

Dissolvable or degradable elastomer functions to dissolve or degrade when exposed to the wellbore conditions in a user controlled fashion, i.e., at a rate and location controlled by the structure of the first component. In this way, zones in a wellbore, or the wellbore itself or branches of the wellbore, may be blocked for periods of time uniquely defined by the user. The dissolvable elastomer may comprise a water-soluble inorganic material, a water-soluble organic material, and combinations thereof. The water-soluble organic material may comprise a water-soluble polymeric material, for example, but not limited to poly(vinyl alcohol), poly(lactic acid), polyester-polyurethane copolymer, polyether-polyurethane copolymer, or polycarbonate-polyurethane copolymer, or the combination and the like. The water-soluble polymeric material may either be a normally water-insoluble polymer that is made soluble by hydrolysis of side chains, or the main polymeric chain may be hydrolysable.

An alternative well fracturing component of the invention comprises a soluble component that is soluble when exposed to a selected wellbore environment, the soluble component including one or more exposure passages or holes to control dissolution of the soluble component at least partially. These well operating element embodiments may or may not have any non-soluble component. A portion of the well operating element that is to seat on a valve seat or other seating may have a non-dissolvable component, such as an end cap, and the like. In certain embodiments, the non-dissolvable component may comprise a shaped object, such as a collet, that provides shape and support for the soluble component.

Thermoplastic elastomers are generally the reaction product of a low equivalent molecular weight polyfunctional monomer and a high equivalent molecular weight polyfunctional monomer, wherein the low equivalent weight polyfunctional monomer is capable, on polymerization, of forming a hard segment (and, in conjunction with other hard segments, crystalline hard regions or domains) and the high equivalent weight polyfunctional monomer is capable, on polymerization, of producing soft, flexible chains connecting the hard regions or domains.

“Thermoplastic elastomers” differ from “thermoplastics” and “elastomers” in that thermoplastic elastomers, upon heating above the melting temperature of the hard regions, form a homogeneous melt which can be processed by thermoplastic techniques (unlike elastomers), such as injection molding, extrusion, blow molding, and the like. Subsequent cooling leads again to segregation of hard and soft regions resulting in a material having elastomeric properties, however, which does not occur with thermoplastics. Commercially available thermoplastic elastomers include segmented polyester thermoplastic elastomers, segmented polyurethane thermoplastic elastomers, segmented polyamide thermoplastic elastomers, blends of thermoplastic elastomers and thermoplastic polymers, and ionomeric thermoplastic elastomers.

“Segmented thermoplastic elastomer”, as used herein, refers to the sub-class of thermoplastic elastomers which are based on polymers which are the reaction product of a high equivalent weight polyfunctional monomer and a low equivalent weight polyfunctional monomer.

“Ionomeric thermoplastic elastomers” refers to a sub-class of thermoplastic elastomers based on ionic polymers (ionomers). Ionomeric thermoplastic elastomers are composed of two or more flexible polymeric chains bound together at a plurality of positions by ionic associations or clusters. The ionomers are typically prepared by copolymerization of a functionalized monomer with an olefinic unsaturated monomer, or direct functionalization of a preformed polymer. Carboxyl-functionalized ionomers are obtained by direct copolymerization of acrylic or methacrylic acid with ethylene, styrene and similar comonomers by free-radical copolymerization. The resulting copolymer is generally available as the free acid, which can be neutralized to the degree desired with metal hydroxides, metal acetates, and similar salts.

Another useful class of polymeric substrate materials are thermoplastic materials. A thermoplastic material is defined as a polymeric material (preferably, an organic polymeric material) that softens and melts when exposed to elevated temperatures and generally returns to its original condition, i.e., its original physical state, when cooled to ambient temperatures. During the manufacturing process of an oilfield element, the thermoplastic material may be heated above its softening temperature, and preferably above its melting temperature, to cause it to flow and form the desired shape of the oilfield element. After the desired shape is formed, the thermoplastic substrate is cooled and solidified. In this way, thermoplastic materials (including thermoplastic elastomers) can be molded into various shapes and sizes.

Thermoplastic materials may be preferred over other types of polymeric materials at least because the product has advantageous properties, and the manufacturing process for the preparation of oilfield elements may be more efficient. For example, an oilfield element formed from a thermoplastic material is generally less brittle and less hygroscopic than an element formed from a thermosetting material. Furthermore, as compared to a process that would use a thermosetting resin, a process that uses a thermoplastic material may require fewer processing steps, fewer organic solvents, and fewer materials, e.g., catalysts. Also, with a thermoplastic material, standard molding techniques such as injection molding can be used. This can reduce the amount of materials wasted in construction.

Moldable thermoplastic materials that may be used are those having a high melting temperature, good heat resistant properties, and good toughness properties such that the oilfield element or assemblies containing these materials operably withstand oilfield conditions without substantially deforming or disintegrating. The toughness of the thermoplastic material can be measured by impact strength, such as Gardner Impact value.

Thermoplastic polymeric substrates useful in the invention are those able to withstand expected temperatures, temperature changes, and temperature differentials (for example a temperature differential from one surface of a gasket to the other surface material to the other surface) during use, as well as expected pressures, pressure changes, and pressure differentials during use, with a safety margin on temperature and pressure appropriate for each application. Additionally, the melting temperature of the thermoplastic material should be sufficiently lower, i.e., at least about 25° C. lower than the melting temperature of any fibrous reinforcing material, and sufficiently higher than the melting temperature of any thermoplastic coating materials to be applied by fluidized bed dip coating. In this way, reinforcing material (if used) is not adversely affected during the molding of the thermoplastic substrate, and the substrate will not melt if a thermoplastic coating is applied by dip coating. Furthermore, the thermoplastic substrate material, if used, should be sufficiently compatible with the material used in the polymeric coating such that the substrate does not deteriorate, and such that there is effective adherence of the coating to the substrate.

Examples of thermoplastic materials suitable for substrates in oilfield elements according to the present invention include polycarbonates, polyetherimides, polyesters, polysulfones, polystyrenes, acrylonitrile-butadiene-styrene block copolymers, acetal polymers, polyamides, or combinations thereof. Of this list, polyamides and polyesters may provide better performance. Polyamide materials are useful at least because they are inherently tough and heat resistant, typically provide good adhesion to coatings without priming, and are relatively inexpensive. Polyamide resin materials may be characterized by having an amide group, i.e., —C(O)NH—. Various types of polyamide resin materials, i.e., nylons, can be used, such as nylon 6/6 or nylon 6. Of these, nylon 6 may be used if a phenolic-based coating is used because of the excellent adhesion between nylon 6 and phenolic-based coatings. Nylon 6/6 is a condensation product of adipic acid and hexamethylenediamine. Nylon 6/6 has a melting point of about 264° C. and a tensile strength of about 770 kg/cm². Nylon 6 is a polymer of c-caprolactam. Nylon 6 has a melting point of about 223° C. and a tensile strength of about 700 kg/cm². Examples of commercially available nylon resins useable as substrates in oilfield elements according to the present invention include those known under the trade designations “Vydyne” from Solutia, St. Louis, Mo.; “Zytel” and “Minion” both from DuPont, Wilmington, Del.; “Trogamid T” from Degussa Corporation, Parsippany, N.J.; “Capron” from BASF, Florham Park, N.J.; “Nydur” from Mobay, Inc., Pittsburgh, Pa.; and “Ultramid” from BASF Corp., Parsippany, N.J. Mineral-filled thermoplastic materials can be used, such as the mineral-filled nylon 6 resin “Minion”, from DuPont.

Suitable thermoset (thermally cured) polymers for use as polymeric substrates in the present invention include those discussed in relation to polymeric coatings, which discussion follows, although the precursor solutions need not be coatable, and may therefore omit certain ingredients, such as diluents. Thermoset molding compositions known in the art are generally thermosetting resins containing inorganic fillers and/or fibers. Upon heating, thermoset monomers initially exhibit viscosities low enough to allow for melt processing and molding of an article from the filled monomer composition. Upon further heating, the thermosetting monomers react and cure to form hard resins with high stiffness. Thermoset polymeric substrates useful in the invention may be manufactured by any method known in the art. These methods include, but are not limited to, reaction injection molding, resin transfer molding, and other processes wherein dry fiber reinforcement plys (preforms) are loaded in a mold cavity whose surfaces define the ultimate configuration of the article to be fabricated, whereupon a flowable resin is injected, or vacuumed, under pressure into the mold cavity (mold plenum) thereby to produce the article, or to saturate/wet the fiber reinforcement preforms, where provided. After the resinated preforms are cured in the mold plenum, the finished article is removed from the mold.

### Polymeric Coatings

“Coating” as used herein as a noun, means a condensed phase formed by any one or more processes. The coating may be conformal (i.e., the coating conforms to the surfaces of the polymeric substrate), although this may not be necessary in all oilfield applications or all oilfield elements, or on all surfaces of the polymeric substrates. Conformal coatings based on urethane, acrylic, silicone, and epoxy chemistries are known, primarily in the electronics and computer industries (printed circuit boards, for example).

Another useful conformal coating includes those formed by vaporization or sublimation of, and subsequent pyrolization and condensation of monomers or dimers and polymerized to form a continuous polymer film, such as the class of polymeric coatings based on poly (p-xylylene), commonly known as Parylene. For example, Parylene N coatings may be formed by vaporization or sublimation of a dimer within formula (I), and subsequent pyrolization and condensation of the divalent radicals within formula (II) to form a polymer within formula (III), although the vaporization is not strictly necessary. In formulas (I), (II), and (III), x and y are both equal to 0 to for a Parylene N coating. Other Parylene coatings may be formed in similar fashion.

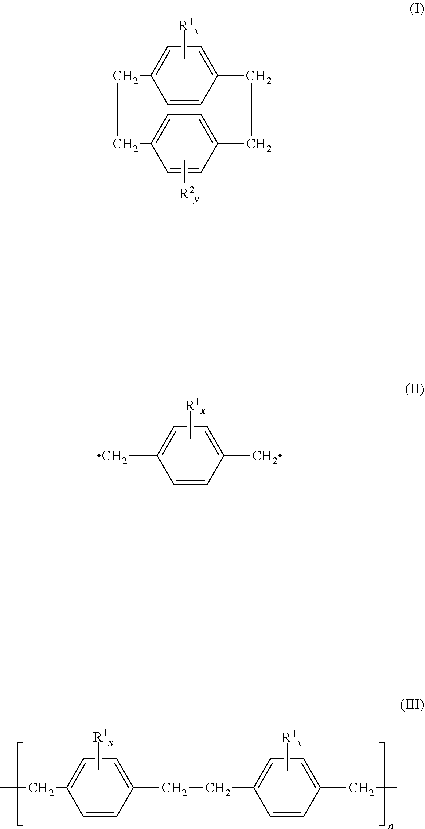

Another class of useful polymeric coatings are thermally curable coatings derived from coatable, thermally curable coating precursor solutions. Coatable, thermally curable coating precursor solutions may comprise a 30-95% solids solution, or 60-80% solids solution of a thermally curable resin having a plurality of pendant methylol groups, the balance of the solution comprising water and a reactive diluent.

The term “coatable”, as used herein, means that the solutions of the invention may be coated or sprayed onto polymeric substrates using coating devices which are conventional in the spray coating art, such as knife coaters, roll coaters, flow-bar coaters, electrospray coaters, ultrasonic coaters, gas-atomizing spray coaters, and the like. This characteristic may also be expressed in terms of viscosity of the solutions. The viscosity of the coatable, thermally curable coating precursor solutions generally should not exceed about 2000 centipoise, measured using a Brookfield viscometer, number 2 spindle, 60 rpm, at 25° C. The term “percent solids” means the weight percent organic material that would remain upon application of curing conditions. Percent solids below about 30% are not practical to use because of VOC emissions, while above about 95% solids the resin solutions are difficult to render coatable, even when heated.

The term “diluent” is used in the sense that the reactive diluent dilutes the concentration of thermally curable resin in the solution, and does not mean that the solutions necessarily decrease in viscosity. The thermally curable resin may be the reaction product of a non-aldehyde and an aldehyde, the non-aldehyde selected from ureas and phenolics. The reactive diluent has at least one functional group which is independently reactive with the pendant methylol groups and with the aldehyde, and may be selected from
A) compounds selected from the group consisting of compounds represented by the general formula R⁷R⁸N(C═X)Y and mixtures thereof wherein X═O or S and Y═—NR⁹R¹⁰ or —OR¹¹, such that when X═S, Y═NR⁹R¹⁰, each of R⁷, R⁸, R⁹, R¹⁰ and R¹¹ is a monovalent radical selected from hydrogen, alkyl groups having 1 to about 10 carbon atoms, hydroxyalkyl groups having from about 2 to 4 carbon atoms and one or more hydroxyl groups, and hydroxypolyalkyleneoxy groups having one or more hydroxyl groups, and which may include the provisos that:
   (i) the compound contains at least one —NH and one —OH group or at least two —OH groups or at least two —NH groups;
   (ii) R⁷ and R⁸ or R⁷ and R⁹ can be linked to form a ring structure; and
   (iii) R⁷, R⁸, R⁹, R¹⁰ and R¹¹ are never all hydrogen at the same time;
B) compounds having molecular weight less than about 300 and selected from the group consisting of alkylsubstituted 2-aminoalcohols, β-ketoalkylamides, and nitro alkanes;
C) poly(oxyalkylene) amines having molecular weight ranging from about 90 to about 1000; and
D) poly(oxyalkylene) ureido compounds having molecular weight ranging from about 90 to about 1000.

Reactive diluents useful in the compositions include those wherein X is O, Y═NR⁹R¹⁰, R⁷ is 2-hydroxyethyl, R⁸ and R⁹ are linked to form an ethylene bridge, and R¹⁰ is hydrogen.

One alkylsubstituted 2-aminoalcohol useful as a reactive diluent is 2-amino-2-methyl-1-propanol, while the β-ketoalkylamide may be β-ketobutyramide. Additionally, nitroalkanes with at least 1 active hydrogen atom attached to the alpha carbon atom will scavenge formaldehyde in coatable thermally curable polymer precursor solutions useful in the invention. Representative poly(oxyalkylene) amines include poly(oxyethylene-co-oxypropylene) amine, poly(oxypropylene) amine, and poly(oxypropylene) diamine, whereas representative poly(oxyalkylene) ureido compounds are the reaction product of urea and the poly(oxyalkylene) amines previously enumerated. Optionally, useful coatable, thermally curable polymeric coating precursor solutions may include up to about 50 weight percent (of the total weight of thermally curable resin) of ethylenically unsaturated monomers. These monomers, such as tri- and tetra-ethylene glycol diacrylate, are radiation curable and can reduce the overall cure time of the thermally curable resins by providing a mechanism for pre-cure gelation of the thermally curable resin.

Two other classes of useful coatings are condensation curable and addition polymerizable resins, wherein the addition polymerizable resins are derived from a polymer precursor which polymerizes upon exposure to a non-thermal energy source which aids in the initiation of the polymerization or curing process. Examples of non-thermal energy sources include electron beam, ultraviolet light, visible light, and other non-thermal radiation. During this polymerization process, the resin is polymerized and the polymer precursor is converted into a solidified polymeric coating. Upon solidification of the polymer precursor, the coating is formed. The polymer in the coating is also generally responsible for adhering the coating to the polymeric substrate, however the invention is not so limited. Additional polymerizable resins are readily cured by exposure to radiation energy. Additional polymerizable resins can polymerize through a cationic mechanism or a free radical mechanism. Depending upon the energy source that is utilized and the polymer precursor chemistry, a curing agent, initiator, or catalyst may be used to help initiate the polymerization.

Examples of useful organic resins to form these classes of polymeric coating include the before-mentioned methylol-containing resins such as phenolic resins, urea-formaldehyde resins, and melamine formaldehyde resins; acrylated urethanes; acrylated epoxies; ethylenically unsaturated compounds; aminoplast derivatives having pendant unsaturated carbonyl groups; isocyanurate derivatives having at least one pendant acrylate group; isocyanate derivatives having at least one pendant acrylate group; vinyl ethers; epoxy resins; and mixtures and combinations thereof. The term “acrylate” encompasses acrylates and methacrylates.

Phenolic resins are widely used in industry because of their thermal properties, availability, and cost. There are two types of phenolic resins, resole and novolac. Resole phenolic resins have a molar ratio of formaldehyde to phenol of greater than or equal to one to one, typically between 1.5:1.0 to 3.0:1.0. Novolac resins have a molar ratio of formaldehyde to phenol of less than one to one. Examples of commercially available phenolic resins include those known by the tradenames. “Durez” and “Varcum” from Durez Corporation, a subsidiary of Sumitomo Bakelite Co., Ltd.; “Resinox” from Monsanto; “Aerofene” from Ashland Chemical Co. and “Aerotap” from Ashland Chemical Co.

Acrylated urethanes are diacrylate esters of hydroxy-terminated, isocyanate (NCO) extended polyesters or polyethers. Examples of commercially available acrylated urethanes include those known under the trade designations “UVITHANE 782”, available from Morton Thiokol Chemical, and “CMD 6600”, “CMD 8400”, and “CMD 8805”, available from Radcure Specialties.

Acrylated epoxies are diacrylate esters of epoxy resins, such as the diacrylate esters of Bisphenol A epoxy resin. Examples of commercially available acrylated epoxies include those known under the trade designations “CMD 3500”, “CMD 3600”, and “CMD 3700”, available from Radcure Specialties.

Ethylenically unsaturated resins include both monomeric and polymeric compounds that contain atoms of carbon, hydrogen, and oxygen, and optionally, nitrogen and the halogens. Oxygen or nitrogen atoms or both are generally present in ether, ester, urethane, amide, and urea groups. Ethylenically unsaturated compounds may have a molecular weight of less than about 4,000 and may be esters made from the reaction of compounds containing aliphatic monohydroxy groups or aliphatic polyhydroxy groups and unsaturated carboxylic acids, such as acrylic acid, methacrylic acid, itaconic acid, crotonic acid, isocrotonic acid, maleic acid, and the like. Representative examples of acrylate resins include methyl methacrylate, ethyl methacrylate styrene, divinylbenzene, vinyl toluene, ethylene glycol diacrylate, ethylene glycol methacrylate, hexanediol diacrylate, triethylene glycol diacrylate, trimethylolpropane triacrylate, glycerol triacrylate, pentaerythritol triacrylate, pentaerythritol methacrylate, pentaerythritol tetraacrylate and pentaerythritol tetraacrylate. Other ethylenically unsaturated resins include monoallyl, polyallyl, and polymethallyl esters and amides of carboxylic acids, such as diallyl phthalate, diallyl adipate, and N,N-diallyladipamide. Still other nitrogen containing compounds include tris(2-acryloyloxyethyl)isocyanurate, 1,3,5-tri(2-methyacryloxyethyl)-triazine, acrylamide, methylacrylamide, N-methylacrylamide, N,N-dimethylacrylamide, N-vinylpyrrolidone, and N-vinylpiperidone.

The aminoplast resins have at least one pendant α,β-unsaturated carbonyl group per molecule or oligomer. These unsaturated carbonyl groups can be acrylate, methacrylate, or acrylamide type groups. Examples of such materials include N-(hydroxymethyl) acrylamide, N,N′-oxydimethylenebisacrylamide, ortho- and para-acrylamidomethylated phenol, acrylamidomethylated phenolic novolac, and combinations thereof.

Isocyanurate derivatives may have at least one pendant acrylate group. Isocyanate derivatives may have at least one pendant acrylate group. The isocyanurate material may be a triacrylate of tris(hydroxy ethyl) isocyanurate.

Epoxy resins have an oxirane and are polymerized by the ring opening. Such epoxide resins include monomeric epoxy resins and oligomeric epoxy resins. Examples of some useful epoxy resins include 2,2-bis[4-(2,3-epoxypropoxy)-phenyl propane](diglycidyl ether of Bisphenol) and commercially available materials under the trade designations “Epon 828”, “Epon 1004”, and “Epon 1001F” available from Shell Chemical Co., Houston, Tex., “DER-331”, “DER-332”, and “DER-334” available from Dow Chemical Co., Freeport, Tex. Other suitable epoxy resins include glycidyl ethers of phenol formaldehyde novolac (e.g., “DEN-431” and “DEN-428” available from Dow Chemical Co.).

Epoxy resins useful in the invention can polymerize via a cationic mechanism with the addition of an appropriate cationic curing agent. Cationic curing agents generate an acid source to initiate the polymerization of an epoxy resin. These cationic curing agents can include a salt having an onium cation and a halogen containing a complex anion of a metal or metalloid. Other cationic curing agents include a salt having an organometallic complex cation and a halogen containing complex anion of a metal or metalloid. Another example is an organometallic salt and an onium salt.

Still other cationic curing agents include an ionic salt of an organometallic complex in which the metal is selected from the elements of Periodic Group IVB, VB, VIB, VIIB and VIIIB.

Regarding free radical curable resins, in some embodiments the polymeric precursor solution may further comprise a free radical curing agent. However, in the case of an electron beam energy source, the curing agent is not always required because the electron beam itself generates free radicals. Examples of free radical thermal initiators include peroxides, e.g., benzoyl peroxide, azo compounds, benzophenones, and quinones. For either ultraviolet or visible light energy source, this curing agent is sometimes referred to as a photo initiator.

Examples of initiators, that when exposed to ultraviolet light generate a free radical source, include but are not limited to those selected from organic peroxides, azo compounds, quinones, benzophenones, nitroso compounds, acryl halides, hydrozones, mercapto compounds, pyrylium compounds, triacrylimdazoles, bisimidazoles, chloroalkytriazines, benzoin ethers, benzil ketals, thioxanthones, and acetophenone derivatives, and mixtures thereof. The initiator for use with visible light may be that known under the trade designation “Irgacure 369” commercially available from Ciba Specialty Chemicals, Tarrytown, N.Y.

### Adhesion Promoters, Coupling Agents and Other Optional Ingredients

For embodiments wherein a better bond between the polymeric coating and the polymeric substrate is desired, mechanical and/or chemical adhesion promotion (priming) techniques may be used. For example, if the polymeric substrate is a thermoplastic polycarbonate, polyetherimide, polyester, polysulfone, or polystyrene material, use of a primer may be preferred to enhance the adhesion between the substrate and the coating. The term “primer” as used in this context is meant to include both mechanical and chemical type primers or priming processes. Examples of mechanical priming processes include, but are not limited to, corona treatment and scuffing, both of which increase the surface area of the backing. An example of a preferred chemical primer is a colloidal dispersion of, for example, polyurethane, acetone, isopropanol, water, and a colloidal oxide of silicon.

Besides the polymeric material, the substrate of the invention may include an effective amount of a fibrous reinforcing material. Herein, an “effective amount” of a fibrous reinforcing material is a sufficient amount to impart at least improvement in the physical characteristics of the substrate, i.e., heat resistance, toughness, flexibility, stiffness, shape control, adhesion, etc., but not so much fibrous reinforcing material as to give rise to any significant number of voids and detrimentally affect the structural integrity of the substrate. The amount of the fibrous reinforcing material in the substrate may be within a range of about 1-40%, or within a range of about 5-35%, or within a range of about 15-30%, based upon the weight of the backing.

The fibrous reinforcing material may be in the form of individual fibers or fibrous strands, or in the form of a fiber mat or web. The mat or web can be either in a woven or nonwoven matrix form. Examples of useful reinforcing fibers in applications of the present invention include metallic fibers or nonmetallic fibers. The nonmetallic fibers include glass fibers, carbon fibers, mineral fibers, synthetic or natural fibers formed of heat resistant organic materials, or fibers made from ceramic materials.

By “heat resistant” organic fibers, it is meant that useable organic fibers must be resistant to melting, or otherwise breaking down, under the conditions of manufacture and use of the coated substrates of the present invention. Examples of useful natural organic fibers include wool, silk, cotton, or cellulose. Examples of useful synthetic organic fibers include polyvinyl alcohol fibers, polyester fibers, rayon fibers, polyamide fibers, acrylic fibers, aramid fibers, or phenolic fibers. Generally, any ceramic fiber is useful in applications of the present invention. An example of a ceramic fiber suitable for the present invention is “Nextel” which is commercially available from 3M Co., St. Paul, Minn. Glass fibers may be used, at least because they impart desirable characteristics to the coated abrasive articles and are relatively inexpensive.

Furthermore, suitable interfacial binding agents exist to enhance adhesion of glass fibers to thermoplastic materials. Glass fibers are typically classified using a letter grade. For example, E glass (for electrical) and S glass (for strength). Letter codes also designate diameter ranges, for example, size “D” represents a filament of diameter of about 6 micrometers and size “G” represents a filament of diameter of about 10 micrometers. Useful grades of glass fibers include both E glass and S glass of filament designations D through U. Preferred grades of glass fibers include E glass of filament designation “G” and S glass of filament designation “G.” Commercially available glass fibers are available from Specialty Glass Inc., Oldsmar, Fla.; Owens-Corning Fiberglass Corp., Toledo, Ohio; and Mo-Sci Corporation, Rolla, Mo. If glass fibers are used, the glass fibers may be accompanied by an interfacial binding agent, i.e., a coupling agent, such as a silane coupling agent, to improve the adhesion to the thermoplastic material. Examples of silane coupling agents include “Z-6020” and “Z-6040,” available from Dow Coming Corp., Midland, Mich.

The substrates of the present invention may further include an effective amount of a toughening agent. This will be preferred for certain applications. A primary purpose of the toughening agent is to increase the impact strength of the substrate. By “an effective amount of a toughening agent”, it is meant that the toughening agent is present in an amount to impart at least improvement in the substrate toughness without it becoming too flexible. The substrates of the present invention preferably include sufficient toughening agent to achieve the desirable impact test values listed above. A substrate of the present invention may contain between about 1% and about 30% of the toughening agent, based upon the total weight of the substrate. For example, the less elastomeric characteristics a toughening agent possesses, the larger quantity of the toughening agent may be required to impart desirable properties to the substrates of the present invention. Toughening agents that impart desirable stiffness characteristics to the backing of the present invention include rubber-type polymers and plasticizers. Of these, the rubber toughening agents may be mentioned, and synthetic elastomers.

Examples of preferred toughening agents, i.e., rubber tougheners and plasticizers, include: toluenesulfonamide derivatives (such as a mixture of N-butyl- and N-ethyl-p-toluenesulfonamide, commercially available from Akzo Chemicals, Chicago, IL., under the trade designation “Ketjenflex 8”); styrene butadiene copolymers; polyether backbone polyamides (commercially available from Atochem, Glen Rock, N.J., under the trade designation “Pebax”); rubber-polyamide copolymers (commercially available from DuPont, Wilmington, Del., under the trade designation “Zytel FN”); and functionalized triblock polymers of styrene-(ethylene butylene)-styrene (commercially available from Shell Chemical Co., Houston, Tex., under the trade designation “Kraton FG1901”); and mixtures of these materials. Of this group, rubber-polyamide copolymers and styrene-(ethylene butylene)-styrene triblock polymers may be used, at least because of the beneficial characteristics they impart to substrates. Rubber-polyamide copolymers may also be used, at least because of the beneficial impact characteristics they impart to the substrates of the present invention. If the backing is made by injection molding, typically the toughener is added as a dry blend of toughener pellets with the other components. The process usually involves tumble-blending pellets of toughener with pellets of fiber-containing thermoplastic material. A more preferred method involves compounding the thermoplastic material, reinforcing fibers, and toughener together in a suitable extruder, pelletizing this blend, then feeding these prepared pellets into the injection molding machine. Commercial compositions of toughener and thermoplastic material are available, for example, under the designation “Ultramid” from BASF Corp., Parsippany, N.J. Specifically, “Ultramid B3ZG6” is a nylon resin containing a toughening agent and glass fibers that is useful in the present invention.

### Optional Substrate Additives

Besides the materials described above, polymeric substrates useful in the invention may include effective amounts of other materials or components depending upon the end properties desired. For example, the substrate may include a shape stabilizer, i.e., a thermoplastic polymer with a melting point higher than that described above for the thermoplastic material. Suitable shape stabilizers include, but are not limited to, poly(phenylene sulfide), polyimides, and polyaramids. An example of a preferred shape stabilizer is polyphenylene oxide nylon blend commercially available from GE Plastics, Pittsfield, Mass., under the trade designation “Noryl GTX 910.” If a phenolic-based coating is employed, however, the polyphenylene oxide nylon blend may not be preferred because of possible nonuniform interaction between the phenolic resin coating and the nylon, resulting in reversal of the shape-stabilizing effect. This nonuniform interaction results from a difficulty in obtaining uniform blends of the polyphenylene oxide and the nylon.

Other such materials that may be added to the substrate for certain applications of the present invention include inorganic or organic fillers. Inorganic fillers are also known as mineral fillers. A filler is defined as a particulate material, typically having a particle size less than about 100 micrometers, preferably less than about 50 micrometers. Examples of useful fillers for applications of the present invention include carbon black, calcium carbonate, silica, calcium metasilicate, cryolite, phenolic fillers, or polyvinyl alcohol fillers. If a filler is used, it is theorized that the filler fills in between the reinforcing fibers and may prevent crack propagation through the substrate. Typically, a filler would not be used in an amount greater than about 20%, based on the weight of the substrate. Preferably, at least an effective amount of filler is used. Herein, the term “effective amount” in this context refers to an amount sufficient to fill but not significantly reduce the tensile strength of the hardened substrate.

Other useful materials or components that can be added to the substrate for certain applications of the present invention include, but are not limited to, oils, antistatic agents, flame retardants, heat stabilizers, ultraviolet stabilizers, internal lubricants, antioxidants, and processing aids. One would not typically use more of these components than needed for desired results.

The apparatus, in particular the polymeric substrates, if filled with fillers, may also contain coupling agents. When an organic polymeric matrix has an inorganic filler, a coupling agent may be desired. Coupling agents may operate through two different reactive functionalities: an organofunctional moiety and an inorganic functional moiety. When a resin/filler mixture is modified with a coupling agent, the organofunctional group of the coupling agent becomes bonded to or otherwise attracted to or associated with the uncured resin. The inorganic functional moiety appears to generate a similar association with the dispersed inorganic filler. Thus, the coupling agent acts as a bridge between the organic resin and the inorganic filler at the resin/filler interface. In various systems this results in:
1. Reduced viscosity of the resin/filler dispersion. Such a dispersion, during a process of preparing a coated substrate, generally facilitates application.
2. Enhanced suspendability of the filler in the resin, i.e., decreasing the likelihood that suspended or dispersed filler will settle out from the resin/filler suspension during storing or processing to manufacture oilfield elements.
3. Improved product performance due to enhanced operation lifetime, for example through increased water resistance or general overall observed increase in strength and integrity of the bonding system.

Herein, the term “coupling agent” includes mixtures of coupling agents. An example of a coupling agent that may be found suitable for this invention is gamma-methacryloxypropyltrimethoxy silane known under the trade designation “Silquest A-174” from GE Silicones, Wilton, Conn. Other suitable coupling agents are zircoaluminates, and titanates.

### Oilfleld Elements, Assemblies, and Wellbores

An “oilfield assembly”, as used herein, is the complete set or suite of oilfield elements that may be used in a particular job. All oilfield elements in an oilfield assembly may or may not be interconnected, and some may be interchangeable.

An “oilfield element” includes, but is not limited to one or more items or assemblies selected from tubing, blow out preventers, sucker rods, O-rings, T-rings, jointed pipe, electric submersible pumps, packers, centralizers, hangers, plugs, plug catchers, check valves, universal valves, spotting valves, differential valves, circulation valves, equalizing valves, safety valves, fluid flow control valves, connectors, disconnect tools, downhole filters, motorheads, retrieval and fishing tools, bottom hole assemblies, seal assemblies, snap latch assemblies, anchor latch assemblies, shear-type anchor latch assemblies, no-go locators, and the like.

A plug for isolating a wellbore is provided. The plug can include one or more lower shear or shearable mechanisms for connecting to a setting tool. The lower shear or shearable mechanism can be located directly on the body of the plug or on a separate component or insert that is placed within the body of the plug. The lower shear or shearable mechanism is adapted to engage a setting tool and release the setting tool when exposed to a predetermined stress that is sufficient to deform the shearable threads to release the setting tool but is less than a stress sufficient to break the plug body.

The term “plug” refers to any tool used to permanently or temporarily isolate one wellbore zone from another, including any tool with blind passages, plugged mandrels, as well as open passages extending completely therethrough and passages that are blocked with a check valve. Such tools are commonly referred to in the art as “bridge plugs,” “frac plugs,” and/or “packers.” And such tools can be a single assembly (i.e. one plug) or two or more assemblies (i.e. two or more plugs) disposed within a work string or otherwise connected thereto that is run into a wellbore on a wireline, slickline, production tubing, coiled tubing or any technique known or yet to be discovered in the art.

A “wellbore” may be any type of well, including, but not limited to, a producing well, a non-producing well, an injection well, a fluid disposal well, an experimental well, an exploratory well, and the like. Wellbores may be vertical, horizontal, deviated some angle between vertical and horizontal, and combinations thereof, for example a vertical well with a non-vertical component.

When an oilfield element is mentioned as being comprised of a coated polymeric substrate, the polymeric substrate may itself be a component of a larger structure, for example coated onto or placed adjacent another material, for example a metallic component.

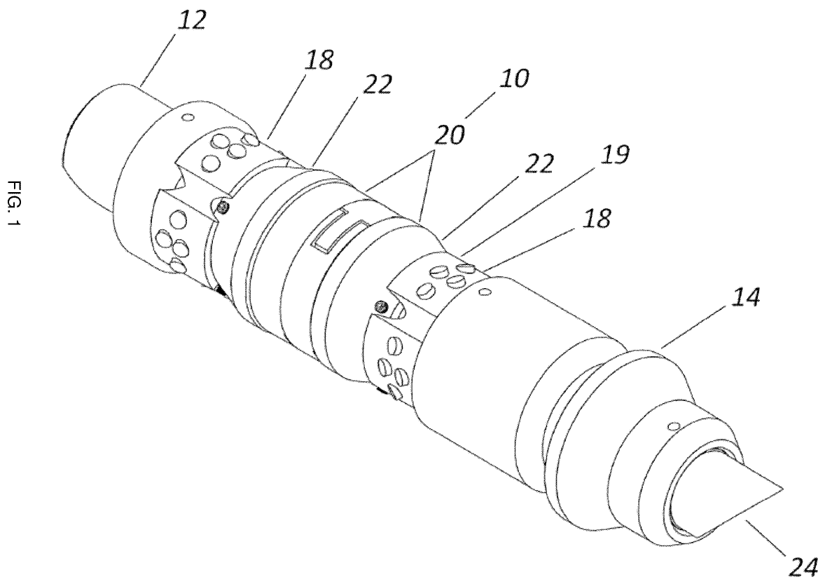

FIG. 1 depicts a schematic perspective view of downhole tool, such as a plug 10, for use in a downhole casing, such as during completion of an oil and gas well. Plug 10, in one embodiment may include at least a mandrel 12. In one embodiment, downhole tools, such as plug 10 of FIG. 1 may include a backup system comprised of pump-out ring 24.

In one embodiment, the plug 10 further includes slips 18 with non-aluminum buttons or inserts 19 of cast iron, tungsten, carbide, or ceramic inserted on the surface thereof to wedge against inner wall of casing (not shown). In one embodiment, the plug 10 further includes an elastomeric seal 20, which may be made of a dissolvable polymeric substrate.

The plug further include a wedge or cone element 22. Mandrel 12 may be dimensioned and function in ways known in the art or in the novel ways described herein. Likewise, slips 18, wedge, or cones 22 operate generally in ways known in the art, for example, to set a tool, but have novel properties and characteristics described herein.

The sealing element in conventional bridge plugs is an elastomeric seal comprised of a rubber or a rubber-like elastomer. Milling out plugs which have rubber or rubber-like polymer seals sometimes creates problems when the milling head encounters the rubber seal. Rubber seals sometimes tend to gum up the milling head and leave gummy debris in the hole, back of which can create problems during completion operations. Embodiments are disclosed herein in which the sealing element does not have to be drilled out, but rather degrades together with the plug generally in the presence of production fluids or fluids added from the wellhead.

In application, sealing elements tend to adhere to one or both interface metal surfaces of the valve or sealed assembly. This can result in fluid or gas leaking through static or dynamic valve seals. In static, or non-moving seals, destructive mechanical stresses may also result from the difference in coefficient of thermal expansion of the mating parts made of differing materials, for example elastomers, polymers, metals or ceramics, or composites of these materials. Although the sealing element may change very little in size between hot and cold conditions, its expansion or contraction is relatively insignificant compared to the adjacent metal sealing elements of the valve, and since sealing elements are mechanically stressed with every thermal cycle, the sealing element eventually fractures thereby allowing fluid or gas to escape.

The polymer coatings discussed herein may significantly improve the performance and lifetime of static seals and dynamic (or sliding sleeve) seals in the aforementioned fluid flow control valves by virtue of the coating's lubricant and wear resistance characteristics and its relative impermeability to gases and fluids. For example a 2 μm coating imparts dry lubricant and wear resistance characteristics to the surface of the sliding seals. The lubricity of coating such as Parylene allows the sealing element to slide across the valve surfaces rather than sticking, thereby accommodating expansion and contraction differences that can fracture the seal. Since the sealing elements are not damaged in use, they can serve their intended sealing function and leaks are eliminated during a long functional life.

As may be seen by the exemplary embodiments, there are many possible uses of coated polymeric substrates formed into oilfield elements and assemblies.

Oilfield assemblies of the invention may include many optional items. One optional feature may be one or more sensors located at a protector bag to detect the presence of hydrocarbons (or other chemicals of interest) in the internal motor lubricant fluid. The chemical indicator may communicate its signal to the surface over a fiber optic line, wire line, wireless transmission, and the like. When a certain chemical is detected that would present a safety hazard or possibly damage a motor if allowed to reach the motor, the pump may be shut down long before the chemical creates a problem.

In summary, generally, this invention pertains primarily to oilfield elements and assemblies comprising a conformal protective coating deposited onto a polymeric substrate, such as dissolvable or degradable polymers, where the substrate may be a thermoplastic, thermoset, elastomeric, or composite material. One coating embodiment is a Parylene coating. Parylene is common name for the family of poly(p-xylylene)s.

The Parylene process was commercialized in the mid-1960s by Union Carbide Corporation, who then transferred patent rights to Cookson Electronics. Parylene forms an almost imperceptible plastic conformal coating that protects materials from many types of environmental problems. While the following process description focuses on the Parylene deposition process, which involves no solvent or diluent, and wherein the monomer undergoes no reaction other than with itself, the invention is not so limited.

Any process and monomer (or combination of monomers, or pre-polymer or polymer particulate or solution) that forms a conformal polymeric coating may be used. Examples of other methods include spraying processes (e.g. electrospraying of reactive monomers, or non-reactive resins); sublimation and condensation; and fluidized-bed coating, wherein, a single powder or mixture of powders which react when heated may be coated onto a heated substrate, and the powder may be a thermoplastic resin or a thermoset resin.

### Parylene Deposition Process.

Parylene is a transparent polymer conformal coating that may be deposited from a gas phase in a medium vacuum. These polymers are polycrystalline and linear in nature, possess superior barrier properties, have extremely good chemical stability, that is, are relatively inert to the hostile well environment and because of the deposition process can be applied uniformly to virtually any surface and shape. A typical Parylene protective coating is about 1,000 times thinner than a plastic sandwich bag. The Parylene deposition process (not a part of the present invention, and publicly available at Cookson Electronics Speciality Coating Systems' website, http://www.scscookson.com.parylene-services/index.cfm) uses a dry, powdered material known as dimer (formula (I) herein) to create a thin, transparent film. There is no intermediate liquid phase and no “cure” cycle. Parylene deposition is via a gas vapor phase deposition; therefore, it is not a line-of-sight coating process. All sides of an object exposed to the vapor phase are uniformly impinged and coated by the gaseous monomer. Multiple parts (plugs, O-rings, and seals for example) may be coated at the same time in an apparatus similar to a clothes washer to make the process very economical to mass-produce finished parts. The process consists of three distinct steps, done in the presence of a medium vacuum.
1. Vaporization, where Parylene is vaporized from its solid dimer state. This is accomplished by the application of heat under vacuum.
2. Pyrolysis (cleaving) of the gaseous form of the dimer into a monomer may be achieved by using a high temperature tube furnace.
3. Polymerization of the gaseous monomer occurs at room temperature as the Parylene deposits as a polymer onto the substrate in the vacuum chamber.

### EXAMPLES

Poly (para-xylene) or Parylene was coated on the surface of dissolvable rubber element by vapor deposition (VDP) coating process. The tests and evaluations described in the following polymers:

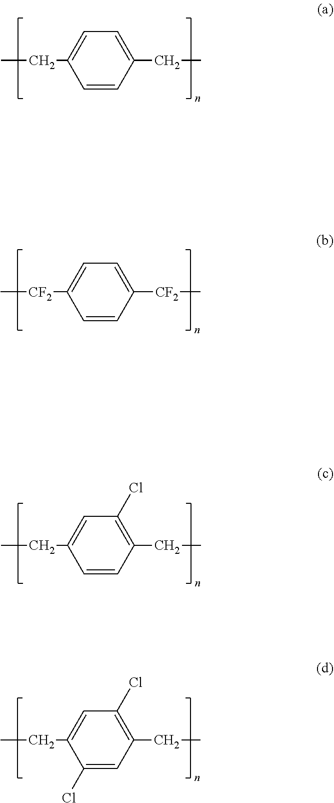

The polymer coating (a) is a linear, highly crystalline material. Polymer coating (b) replaces the alpha hydrogen atoms with fluorine atoms. Polymer coating (b) has the highest temperature rating and most chemical resistance. Polymer b is the coating used in the work. Polymer coating (c) is the modification of polymer coating (a) by substitution of a chlorine atom with one hydrogen atom. Polymer coating (c) displays better barrier properties than polymer coating (a). Polymer coating (d) is the modification of polymer coating (a) by substitution of two chlorine atoms with two hydrogen atoms. Polymer coating (d) has a slightly better temperature rating than polymer coating (c).

The thickness of the Parylene coating may be designed to balance the properties of delaying the dissolvable rubber dissolution and maintain pressure holding. The high thickness coating could help to improve the barrier properties, but sacrifices the sealing properties. The thickness of the coating could range from 0.001 to 100 micrometer. The ideal range of the coating thickness can be from 0.5 to 30 micrometer.

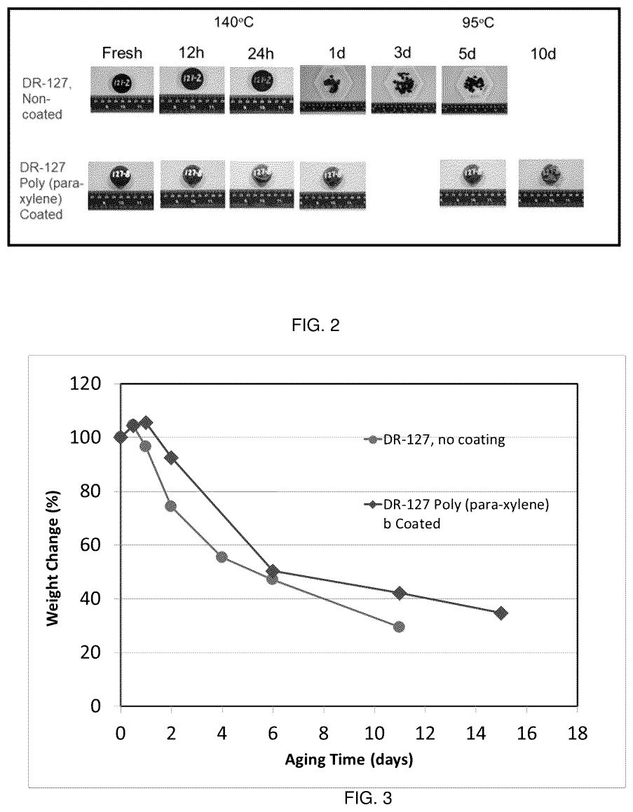

FIG. 2 displays the dissolution progress of a dissolvable rubber DR-127 coupon without coating, a DR-127 coupon coated with poly (para-xylene) b 12 μm coating at 140° C., 0.3% KCl, 24 hrs and then at 95° C., 0.3% KCl for 10 days. DR-127 coupon without coating was fractured after aging at 140° C. for 24 hours, was broken to pieces after aging at 95° C. for 1 dayDR-127 coupon coated with poly(para-xylene) b coating was fractured after aging at 95° C. for 10 days, was fractured after aging at 95° C. for 15 days. The results suggest the silicone coating delayed the dissolution of DR-127 coupon for 2 days, while the poly (para-xylene) b coating delayed the dissoltuion of DR-127 coupon for 14 days.

FIG. 3 shows the weight loss vs time for the three DR-127 coupons. Afterwards, the weight loss of the silicone coated coupon was comparable to that of DR-127 coupon without coating. The results suggest the silicone coating could temporarily delay the dissolution of the dissolvable rubber material. On the other hand, the weight loss rate of poly (para-xylene) b coated DR-127 coupon was obviously slower than that of DR-127 coupon without coating. The results suggest the poly (para-xylene) b coating could delay the dissolution rate of DR-127 element significantly.

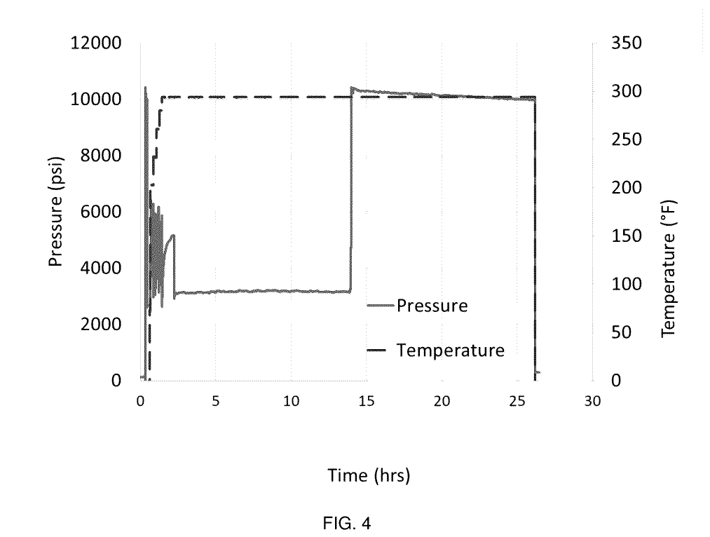

Two high temperature plugs were designed with rubber sealing element made of DR-127 coated with poly (para-xylene) b coating 12 μm. The plug was set first at ambient temperature, then soaked in water at 150° C. for 12 hours. Afterwards, a 10,000 psi pressure hold was performed on the plug. The pressure held stable for 12 hours. The plug only lost 400 psi during the 12 hours holding at 10 ksi. The testing results meet the high temperature dissolvable plug pressure holding testing requirements, as shown in FIG. 4.

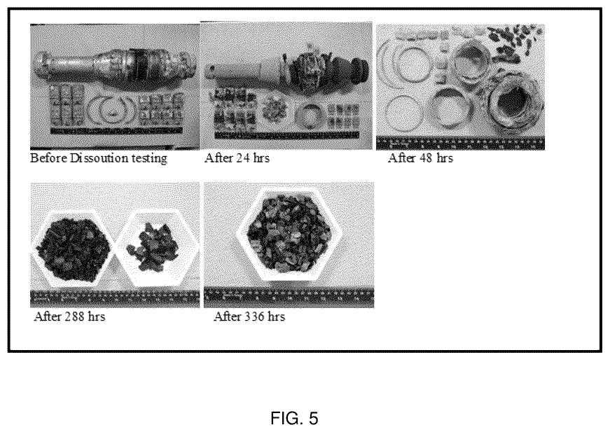

FIG. 5 shows the dissolution progress of one high temperature (HT) dissolvable plug with poly (para-xylene) b 12 μm coated DR-127 element at 95° C. in 1% KCl after pressure holding test. The metal parts were completely dissolved in 72 hrs. The dissolvable rubber element broken to pieces <2 cm after 336 hrs (14 days). The total weight loss of the plug was 95.5%. The dissolution testing results meet the HT dissolvable plug dissolution testing requirements.

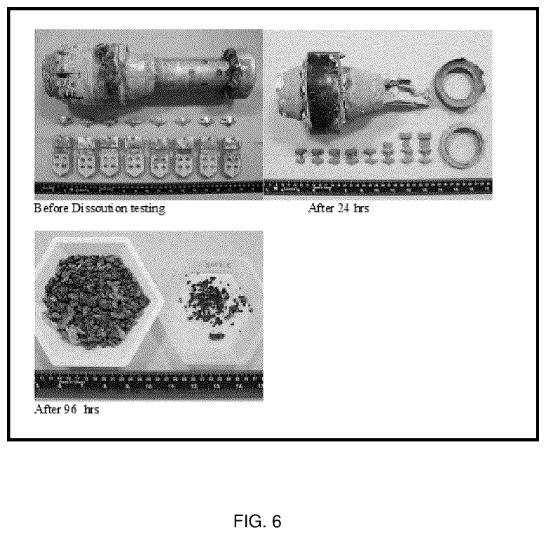

FIG. 6 shows the dissolution progress of one HT dissolvable plug with poly (para-xylene) b 12 μm at 95° C. in 1% KCl after the dissolvable metal parts were completely dissolved. Afterwards, the dissolvable rubber element was dissolved at 130° C. in 1% KCl. The metal parts were completed dissolved after 48 hrs. The dissolvable rubber element dissolved to pieces <2 cm in 96 hours. The total weight loss of the plug was >95.8%.

Examples demonstrate that a Parylene coating is highly effective in protecting an elastomer substrate; therefore, it can significantly lengthen the operational life of the plugs compared to a non-coated plugs. The Parylene coating protects the elastomer from chemical attack and decreases its permeability to conductive and corrosive fluids and gases such as salt water. Therefore it lengthens the life of plugs. However, the process can be applied generally to many elastomers used in the oilfield. The Example test results show the benefits can be significant.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, no clauses are intended to be in the means-plus-function format allowed by 35 U.S.C. § 112, paragraph 6 unless “means for” is explicitly recited together with an associated function. “Means for” clauses are intended to cover the structures described herein as performing the recited function and not only structural equivalents, but also equivalent structures.

The above shows and describes the basic principles, main features and advantages of the utility patent application. Those skilled in the industry should understand that the present utility patent application is not limited by the above-mentioned embodiments. The above-mentioned embodiments and the description are only preferred examples of the present utility patent application and are not intended to limit the present utility patent application, without departing from the present utility patent application. Under the premise of spirit and scope, the present utility patent application will have various changes and improvements, and these changes and improvements fall within the scope of the claimed utility patent application. The scope of protection claimed by the utility patent application is defined by the appended claims and their equivalents.

We claim:

1. An apparatus comprising:
(a) a dissolvable polymeric substrate formed into a downhole tool; and
(b) a polymeric coating adhered to at least a portion of the polymeric substrate, wherein the polymeric coating comprises a polymer having the formula:
—[R(R¹ₓ)(R²_{y})]ₙ—,
wherein R is aryl, or —C(R³ₚ) (R⁴_{q})-aryl-C(R⁵ᵣ)(R⁶ₛ), and n is an integer ranging from 10 to 50,000,
if R is aryl, R¹ and R² are the same or different and are any organic or inorganic group that can be substituted on aromatic nuclei, and x and y are integers ranging from 0 to m, and x+y≤m, wherein m is the maximum number of substitution positions on the aryl, if R is —C(R³ₚ)(R⁴_{q})-aryl-C(R⁵ᵣ)(R⁶ₛ)—, x and y are integers ranging from 0 to m, and x+y≤m, wherein m is the maximum number of substitution positions on the aryl, R¹ and R² are attached to the aryl group and are independently selected from any organic or inorganic group that can be substituted on aromatic nuclei, R³, R⁴, R⁵, R⁶ are independently selected from halogen atoms and hydrogen atoms, p, g, r, and s may be 0, 1, or 2, with p+q=2 and r+s=2.

2. The apparatus, of claim 1, wherein the polymer in the polymeric coating has the following formula 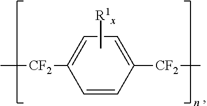
wherein, n is an integer ranging from 10 to 0,000, x is an integer ranging from 0 to 4, R¹ is selected from alkyl, aryl, alkenyl, amino, cyano, carboxyl, alkoxy, hydroxy alkyl, carbalkoxy, hydroxyl, nitro, hydrogen atom, and a halogen atom.

3. The apparatus of claim 1, wherein the polymer in the polymeric coating is selected from poly-(p-xylene, poly-(choro-p-xylylene), poly-(di-choro-p-xylylene), poly-(bromo-p-xylylene), poly-(cyano-p-xylylene), poly(ispropyl-p-xylylene)and poly-(ethyl-p-xylylene) and the coating thickness is from about 0.5 to about 30 micrometer.

4. The apparatus of claim 1, wherein R is aryl, and the polymer in the polymeric coating is selected from polynaphthalene, polyanthracene, polyphenanthrene, polyphenylene, derivatives thereof, and combinations thereof.

5. The apparatus of claim 1, wherein the dissolvable polymeric substrate comprises a polymer selected from thermoplastic polymers, elastomers, composites, and combinations thereof.

6. The apparatus of claim 1, wherein the polymeric coating comprises polymers selected from thermoset polymers, thermoplastic polymers, and combinations thereof.

7. The apparatus of claim 1, wherein the polymeric coating is conformal to at least a portion of a surface of the polymeric substrate.

8. The apparatus of claim 7, wherein the polymeric coating comprises a polymer selected from polyurethanes, polyacrylates, and epoxy polymers.

9. The apparatus of claim 5, wherein the dissolvable polymeric substrate comprises a polymer selected from polyester-polyurethane copolymer, polyether-polyurethane copolymer, or polycarbonate-polyurethane copolymer, or the combination and combinations thereof.

10. The apparatus of claim 1, wherein the polymeric coating is adhered to a primed surface of the polymeric substrate.

11. The apparatus of claim 1, wherein the apparatus is selected from, plugs, lubing, jointed pipe, sucker rods, electric submersible pumps, submersible pump motor protector bags, packers, packer elements, blow out preventers, blow our preventer elements, O-rings, T-rings, centralizers, hangers, plug catchers, check valves, universal valves, spotting valves, differential valves, circulation valves, equalizing valves, safety valves, fluid flow control valves, sliding seals, connectors, disconnect tools, downhole filters, motorheads, retrieval and fishing tools, bottom hole assemblies, seal assemblies, snap latch assemblies, anchor latch assemblies, shear-type anchor latch assemblies, no-go locators, sensor protectors, gaskets, pump shaft seals, tube seals, valve seals, seals and insulators used in electrical components, seats used in fiber optic connections, pressure sealing elements fluids and combinations thereof.

12. An oilfield assembly for exploring, drilling, or producing hydrocarbons, comprising: one or more oilfield elements selected from tubing, jointed pipe, sucker rods, electric submersible pumps, submersible pump motor protector bags, packers, packer elements, blow out preventers, blow out preventer elements, O-rings, T-rings, centralizers, hangers, plugs, plug catchers, check valves, universal valves, spotting valves, differential valves, circulation valves, equalizing valves, safety valves, fluid flow control valves, sliding seals, connectors, disconnect tools, downhole filters, motorheads, retrieval and fishing tools, bottom hole assemblies, seal assemblies, snap latch assemblies, anchor latch assemblies, shear-type anchor latch assemblies, no-go locators, sensor protectors, gaskets, pump shaft seals, tube seals, valve seals, seals and insulators used in electrical components, seals used in fiber optic connections, pressure sealing elements for fluids, and combinations thereof,
wherein at least one of the one or more oilfield elements comprises a dissolvable polymeric substrate having a polymeric coating adhered to at least a portion of the dissolvable polymeric substrate, wherein
the polymeric coating comprises a polymer having the formula —[R(R¹ₓ)(R²_{Y}]ₙ—,
wherein R is aryl, or —C(R³ₚ)(R⁴_{q})-aryl-C(R⁵ᵣ)(R⁶ₛ), and n is an integer ranging from 10 to 10,000, if R is aryl, R¹ and R² are the same or different and are any organic or inorganic group that can be substituted on aromatic nuclei, and x and y are integers ranging from 0 to m, and x+y≤m, wherein m is the total number of available aryl substitution positions,
if R is —C(R³ₚ)(R⁴_{q})-aryl-C(R⁵ᵣ)(R⁶ₛ)—, x and y are integers ranging from 0 to 4, and x+y≤m, wherein m is the maximum number of substitution positions on the aryl, R¹ and R² are attached to the aryl group and are independently selected from any organic or inorganic group that can be substituted on aromatic nuclei, R³, R⁴, R⁵, and R⁶ are independently selected from halogen atoms and hydrogen atoms, p, g, r, and s may be 0, 1, or 2, with p+q=2 and r+s=2.

13. The oilfield assembly of claim 12, wherein the polymer in the polymeric coating has the following formula 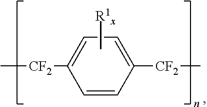
wherein, n is an integer ranging from 10 to 50,000, x is an integer ranging from 0 to 4, R¹ is selected from alkyl, aryl, alkenyl amino, cyano, carboxyl, alkoxy, hydroxy alkyl, carboalkoxy, hydroxyl, nitro, hydrogen atom, and a halogen atom.

14. The oilfield assembly of claim 12, wherein the dissolvable polymeric substrate comprises a polymer selected from polyester-polyurethane copolymer, polyether-polyurethane copolymer, or polycarbonate-polyurethane copolymer, or the combination and combinations thereof.

15. A method comprising:
(a) selecting one or more oilfield elements having a component comprising a dissolvable polymeric substrate having a polymeric coating adhered to at least a portion of the dissolvable polymeric substrate, wherein:
the polymeric coating comprises a polymer having the formula —[R(R¹ₓ)(R²_{y})]ₙ—,
wherein R is aryl, or —C(R³ₚ)(R⁴_{g})-aryl-C(R⁵ᵣ)(R⁶ₛ)—, and n is an integer ranging from 10 to 50,000,
if R is aryl, R¹ and R² are the same or different and are any organic or inorganic group that can be substituted on aromatic nuclei, and x and y are integers ranging from 0 to m, and x+y≤m, wherein m is the maximum number of substitution positions on the aryl, if R is —C(R³ₚ)(R⁴_{q})-aryl-C(R⁵ᵣ)(R⁶ₛ)—, x and y are integers ranging from 0 to m, and x+y≤m, wherein m is the maximum number of substitution positions on the aryl, R¹ and R² are attached to the aryl group and are independently selected from any organic or inorganic group that can be substituted on aromatic nuclei, R³, R⁴, R⁵, and Rare independently selected from halogen atoms and hydrogen atoms, p, g, r, and s may be 0, 1, or 2, with p+q=2 and r+s=2; and
(b) using the oilfield element in an oilfield operation, thus exposing the oilfield element to an oilfield environment.

16. The method of claim 15, wherein the one or more oilfield elements are selected from lubing, jointed pipe, sucker rods, electric submersible pumps, submersible pump motor protector bags, packers, packer elements, blow out preventers, blow out preventer elements, O-rings, T-rings, centralizers, hangers, plugs, plug catchers, check valves, universal valves, spotting valves, differential valves, circulation valves, equalizing valves, safely valves, fluid flow control valves, sliding seals, connectors, disconnect tools, downhole filters, motorheads, retrieval and fishing tools, bottom hole assemblies, seal assemblies, snap latch assemblies, anchor latch assemblies, shear-type anchor latch assemblies, no-go locators, sensor protectors, gaskets, pump shaft seals, tube seals, valve seals, seals and insulators used in electrical components, seals used in fiber optic connections, pressure sealing elements for fluids, and combinations thereof.

17. The method of claim 15, wherein the polymer in the polymeric coating has the following formula 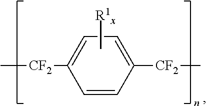
wherein, n is an integer ranging from 10 to 50,000, x is an integer ranging from 0 to 4, R¹ is selected from alkyl, aryl, alkenyl amino, cyano, carboxyl, alkoxy, hydroxy alkyl, carboalkoxy, hydroxy, nitro, hydrogen atom, and a halogen atom.

18. The method of claim 15, wherein the dissolvable polymeric substrate comprises a polymer selected from thermoplastic polymers, elastomers, composites, and combinations thereof.

19. The method of claim 18, wherein the dissolvable polymeric substrate comprises a polymer selected from polyester-polyurethane copolymer, polyether-polyurethane copolymer, or polycarbonate-polyurethane copolymer, or the combination and combinations thereof.

20. The method of claim 15, wherein the polymeric coating comprises polymers selected from thermoset polymers, thermoplastic polymers, and combinations thereof.
